(19) United States
(12) Patent Application Publication
(10) Pub. No.: US 2026/0072311 A1
(43) Pub. Date: Mar. 12, 2026

(54) BACKLIGHT UNIT AND DISPLAY APPARATUS INCLUDING THE SAME

(71) Applicant: SAMSUNG ELECTRONICS CO., LTD., Suwon-si (KR)

(72) Inventors: Sungyeol KIM, Suwon-si (KR); Hyungjin KIM, Suwon-si (KR); Junsung CHOI, Suwon-si (KR)

(73) Assignee: SAMSUNG ELECTRONICS CO., LTD., Suwon-si (KR)

(21) Appl. No.: 19/383,103

(22) Filed: Nov. 7, 2025

Related U.S. Application Data
(63) Continuation of application No. PCT/KR2025/013232, filed on Aug. 29, 2025.

(30) Foreign Application Priority Data
Sep. 12, 2024 (KR) 10-2024-0125124
Dec. 4, 2024 (KR) 10-2024-0179007

(51) Int. Cl. G02F 1/1335; G02F 1/13357

(52) U.S. Cl. CPC G02F 1/133613; G02F 1/133603; G02F 1/133611; G02F 1/133612

(57) ABSTRACT

There is provided a display apparatus including a liquid crystal panel and a backlight unit configured to provide light to the liquid crystal panel, and the backlight unit may include a substrate; and a plurality of dimming blocks arranged in a plurality of rows and a plurality of columns on the substrate, each including a red light emitting diode (LED), a green LED, and a blue LED, and each of the red LED, the green LED, and the blue LED included in each of the plurality of dimming blocks may be divided into different numbers of LED cells, and the divided LED cells may be connected in series.

### CROSS-REFERENCE TO RELATED APPLICATIONS

This application is a continuation of International Application No. PCT/KR2025/013232, filed on Aug. 29, 2025, which is based on and claims priority to Korean Patent Application No. 10-2024-0125124, filed on Sep. 12, 2024, in the Korean Intellectual Property Office, and to Korean Patent Application No. 10-2024-0179007, filed on Dec. 4, 2024, in the Korean Intellectual Property Office, the disclosures of which are incorporated by reference herein in their entireties.

### BACKGROUND

### 1. Field

The disclosure relates to a display apparatus, and more particularly, to a display apparatus including a liquid crystal panel and a backlight unit (BLU).

### 2. Description of Related Art

Generally, a display apparatus is a type of output device that converts acquired or stored electrical information into visual information and displays the converted information to a user, and is used in various fields such as homes and business places.

The display apparatus includes a backlight unit (BLU) that provides light to a liquid crystal panel, and the backlight unit includes a plurality of point light devices capable of independently emitting light. The light emitting device includes, for example, a light emitting diode (LED) or an organic light emitting diode (OLED).

Local dimming technology used in the backlight unit of LED TVs is a key technology for increasing the contrast ratio of display. A local dimming system divides a display screen into several zones and independently controls current for each zone according to an input image. Accordingly, the local dimming system reduces current when an input image is dark and increases current when an input image is bright, thereby effectively improving the contrast ratio.

When such a local dimming system is implemented in an LED backlight based on Red/Green/Blue LEDs, the block voltage for each color LED may be different when driving using a block common voltage.

### SUMMARY

An aspect of the disclosure is to provide a backlight unit and a display apparatus including the same, in which the number of light emitting diode (LED) cells is varied depending on the color of LEDs included in the backlight unit, allowing block voltages of LEDs for each color to be similar to each other.

In addition, an aspect of the disclosure is to provide a backlight unit and a display apparatus including the same, in which current is distributed to each LED cell, allowing the LED cells to be driven with relatively low current, thereby increasing driving efficiency.

The technical objects intended to be achieved by the disclosure are not limited to the above-mentioned technical objects, and other technical objects not mentioned will be clearly understood by one of ordinary skill in the technical art to which the disclosure belongs from the following description.

There is provided a display apparatus including: a liquid crystal panel; and a backlight unit configured to provide light to the liquid crystal panel, wherein the backlight unit includes: a substrate; and a plurality of light emitting devices, each including ones of red light emitting diodes (LEDs), green LEDs, and blue LEDs, at least one of the plurality of light emitting devices comprises a plurality of LED cells, the plurality of LED cells including a first LED cell, a second LED cell, and a third LED cell, the first LED cell including a first number of the red LEDs, the second LED cell including a second number of the green LEDs, and the third LED cell including a third number of the blue LEDs, and the first LED cell, the second LED cell, and the third LED cell are connected in series.

The first number of the red LEDs of the first LED cell may be equal to or greater than the second number of the green LEDs of the second LED cell, and the second number of the green LEDs of the second LED cell may be greater than the third number of the blue LEDs of the third LED cell.

The first number of the red LEDs of the first LED cell may be less than a sum of the second number of the green LEDs of the second LED cell and the third number of the blue LEDs of the third LED cell.

The third number of the blue LEDs of the third LED cell may be two, the second number of the green LEDs of the second LED cell may be three, and the first number of the red LEDs of the first LED cell may be four.

The display apparatus may also include a plurality of dimming blocks, including at least a first dimming block and a second dimming block, arranged in a plurality of rows and a plurality of columns on the substrate, each including the plurality of light emitting devices; and a plurality of driving devices configured to drive ones of the plurality of dimming blocks, at least one of the driving devices may be configured to drive both the first dimming block and the second dimming block, and at least one of the driving devices may be configured to supply a driving current to ones of the plurality of light emitting devices of the first dimming block and the second dimming block.

The display apparatus may also include a plurality of current supply lines configured to allow each of the plurality of driving devices to supply the driving current, the plurality of current supply lines including a first current supply line, a second current supply line, and a third current supply line, and the first current supply line may be arranged to supply the driving current from the at least one of the driving devices and to the first number of the red LEDs of the at least one of the plurality of light emitting devices, and the second current supply line may be arranged to supply the driving current from the at least one of the driving devices and to the second number of the green LEDs of the at least one of the plurality of light emitting devices, and the third current supply line may be arranged to supply the driving current from the at least one of the driving devices and to the third number of the blue LEDs of the at least one of the plurality of light emitting devices.

The driving devices may be disposed on at least one of an upper surface of the substrate and a lower surface of the substrate.

Each of the plurality of dimming blocks may include a preset number of the plurality of light emitting devices.

There is provided a backlight unit, including: a substrate; and a plurality of light emitting devices, each including ones of red light emitting diodes (LEDs), green LEDs, and blue LEDs, at least one of the plurality of light emitting devices comprises a plurality of LED cells, the plurality of LED cells including a first LED cell, a second LED cell, and a third LED cell, the first LED cell including a first number of the red LEDs, the second LED cell including a second number of the green LEDs, and the third LED cell including a third number of the blue LEDs, and the first LED cell, the second LED cell, and the third LED cell are connected in series.

The first number of the red LEDs of the first LED cell may be equal to or greater than the second number of the green LEDs of the second LED cell, and the second number of the green LEDs of the second LED cell may be greater than the third number of the blue LEDs of the third LED cell.

The first number of the red LEDs of the first LED cell may be less than a sum of the second number of the green LEDs of the second LED cell and the third number of the blue LEDs of the third LED cell.

The third number of the blue LEDs of the third LED cell may be two, the second number of the green LEDs of the second LED cell may be three, and the first number of the red LEDs of the first LED cell may be four.

The backlight unit may include a plurality of dimming blocks, including at least a first dimming block and a second dimming block, arranged in a plurality of rows and a plurality of columns on the substrate, each including the plurality of light emitting devices; and a plurality of driving devices configured to drive ones of the plurality of dimming blocks, at least one of the driving devices is configured to drive both the first dimming block and the second dimming block, and at least one of the driving devices is configured to supply a driving current to ones of the plurality of light emitting devices of the first dimming block and the second dimming block.

The backlight unit may include a plurality of current supply lines configured to allow each of the plurality of driving devices to supply the driving current, the plurality of current supply lines including a first current supply line, a second current supply line, and a third current supply line, the first current supply line may be arranged to supply the driving current from the at least one of the driving devices and to the first number of the red LEDs of the at least one of the plurality of light emitting devices, the second current supply line may be arranged to supply the driving current from the at least one of the driving devices and to the second number of the green LEDs of the at least one of the plurality of light emitting devices, and the third current supply line may be arranged to supply the driving current from the at least one of the driving devices and to the third number of the blue LEDs of the at least one of the plurality of light emitting devices.

The driving devices may be disposed on at least one of an upper surface of the substrate and a lower surface of the substrate.

### BRIEF DESCRIPTION OF THE DRAWINGS

The above and other aspects, features, and advantages of specific embodiments of the present disclosure will be more apparent from the following description with reference to the accompanying drawings, in which:

FIG. 1 illustrates an example of an appearance of a display apparatus according to one or more embodiments of the disclosure;

FIG. 2 illustrates an example of a structure of a display apparatus according to one or more embodiments of the disclosure;

FIG. 3 illustrates an example of a liquid crystal panel included in a display apparatus according to one or more embodiments of the disclosure;

FIG. 4 illustrates an example of a backlight unit (BLU) included in a display apparatus according to one or more embodiments of the disclosure;

FIG. 5 is a diagram illustrating that a plurality of light emitting diodes of a backlight unit are divided into dimming blocks according to one or more embodiments of the disclosure;

FIG. 6 is a control block diagram of a display apparatus according to one or more embodiments of the disclosure;

FIG. 7 illustrates an example of converting image data into dimming data, performed by a display apparatus according to one or more embodiments of the disclosure;

FIG. 8 illustrates an example of a light emitting device included in a backlight unit according to one or more embodiments of the disclosure;

FIG. 9 illustrates a plurality of local dimming blocks according to one or more embodiments of the disclosure;

FIG. 10 illustrates an arrangement of a dimming driver, driving devices, and light emitting devices included in a display apparatus according to one or more embodiments of the disclosure;

FIG. 11 illustrates that each light emitting device is divided into a plurality of cells according to one or more embodiments of the disclosure;

FIG. 12 illustrates a cell voltage of each light emitting device according to one or more embodiments of the disclosure;

FIG. 13 illustrates connection relationships of a plurality of cells of each light emitting device according to one or more embodiments of the disclosure; and

FIG. 14 and FIG. 15 illustrate connection wiring between a driving device and each light emitting device according to one or more embodiments of the disclosure.

### DETAILED DESCRIPTION

Configurations illustrated in the embodiments and the drawings described in the disclosure are only example embodiments of the disclosure, and thus it is to be understood that various modified examples, which may replace the embodiments and the drawings described in the disclosure, are possible when filing the present application.

Also, like reference numerals or symbols denoted in the drawings of the disclosure represent members or components that perform substantially the same functions.

Also, the terms used in the disclosure are merely used to describe the embodiments, and are not intended to limit and/or restrict the disclosure. An expression used in the singular encompasses the expression of the plural, unless it has a clearly different meaning in the context. In the disclosure, it is to be understood that the terms such as “comprising”, “including” or “having”, etc., are intended to indicate the existence of the features, numbers, steps, operations, components, parts, or combinations thereof disclosed in the disclosure, and are not intended to preclude the possibility that one or more other features, numbers, steps, operations, components, parts, or combinations thereof may exist or may be added.

In this disclosure, it will be understood that when a certain component is referred to as being “connected” or “coupled” to another component, it can be directly or indirectly connected or coupled to the other component.

Also, it will be understood that, although the terms including ordinal numbers, such as “first”, “second”, etc., may be used herein to describe various components, these components should not be limited by these terms. These terms are only used to distinguish one component from another. For example, a first component could be termed a second component, and, similarly, a second component could be termed a first component, without departing from the scope of the present disclosure. As used herein, the term “and/or” includes any and all combinations of one or more of associated listed items.

Hereinafter, an embodiment of the disclosure will be described in detail with reference to the accompanying drawings.

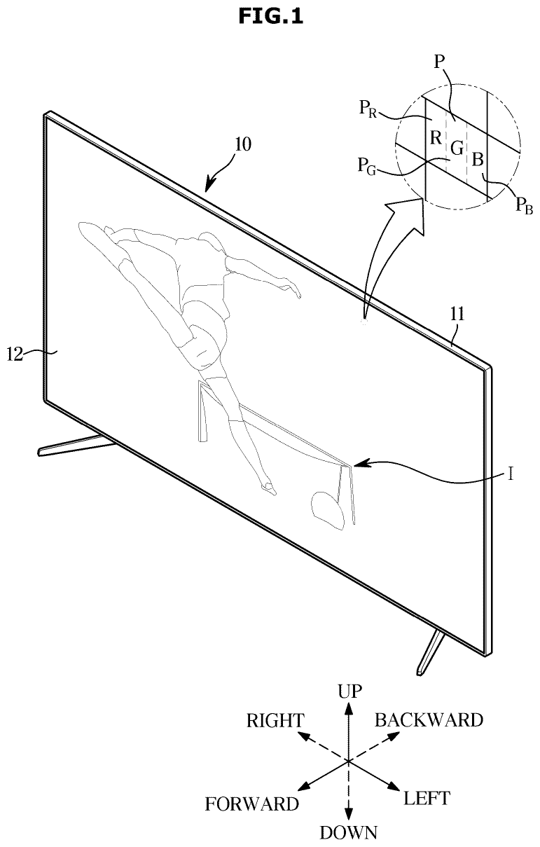

FIG. 1 illustrates an example of an appearance of a display apparatus according to one or more embodiments of the disclosure.

Referring to FIG. 1, a display apparatus 10 may process an image signal received from outside to generate an image and visually display the processed image. Hereinafter, the display apparatus 10 is assumed to be a television (TV). However, the display apparatus 10 may be implemented, for example, as one of various apparatuses, such as a monitor, a portable multimedia apparatus, a portable communication apparatus, etc. That is, the display apparatus 10 may be any kind of apparatus that visually displays images.

Also, the display apparatus 10 may be a large format display (LFD) that is installed in an outdoor space, such as the top of building or a bus stop. The outdoor space is not limited to open-air spaces, and the display apparatus 10 according to one or more embodiments of the disclosure may be installed in any place where many people come in and out, such as a subway station, a shopping mall, a theater, an office, a store, etc., although the place is an indoor space.

The display apparatus 10 may receive content including a video signal and an audio signal from various content sources, and output video and audio corresponding to the video signal and audio signal. For example, the display apparatus 10 may receive content data through a broadcasting reception antenna or a wired cable, receive content data from a content reproducing apparatus, or receive content data from a content providing server of a content provider.

As shown in FIG. 1, the display apparatus 10 may include a main body 11 and a screen 12 that displays an image I.

The main body 11 may form an appearance of the display apparatus 10, and components for enabling the display apparatus 10 to display an image I or perform various functions may be installed inside the main body 11. The main body 11 shown in FIG. 1 may be in a shape of a flat plate, however, the shape of the main body 11 is not limited to that shown in FIG. 1. For example, the main body 11 may be in a shape of a curved plate.

The screen 12 may be formed on a front surface of the main body 11 and display an image I. For example, the screen 12 may display a still image or a moving image. Also, the screen 12 may display a two-dimensional image or a three-dimensional image using a user's binocular disparity.

The screen 12 may include a liquid crystal panel for transmitting or blocking light emitted from a backlight unit (BLU), etc.

In the screen 12, a plurality of pixels P may be formed, and an image I displayed on the screen 12 may be formed by light emitted from the plurality of pixels P. For example, light emitted from the plurality of pixels P may be combined like a mosaic to form an image I on the screen 12.

Each of the plurality of pixels P may emit light having various brightness and various colors. To emit light having various colors, each of the plurality of pixels P may include a plurality of sub pixels, sub pixel PR, sub pixel PG, and sub pixel PB.

The sub pixels, sub pixel PR, sub pixel PG, and sub pixel PB may include a red sub pixel PR capable of emitting red light, a green sub pixel PG capable of emitting green light, and a blue sub pixel PB capable of emitting blue light. For example, the red light may correspond to light of a wavelength range from about 700 nm (nanometer, one billionth of a meter) to about 800 nm, the green light may correspond to light of a wavelength range from about 500 nm to about 600 nm, and the blue light may correspond to light of a wavelength range from about 400 nm to about 500 nm.

Each of the plurality of pixels P may emit light having various brightness and various colors by a combination of red light from the red sub pixel PR, green light from the green sub pixel PG, and blue light from the blue sub pixel PB.

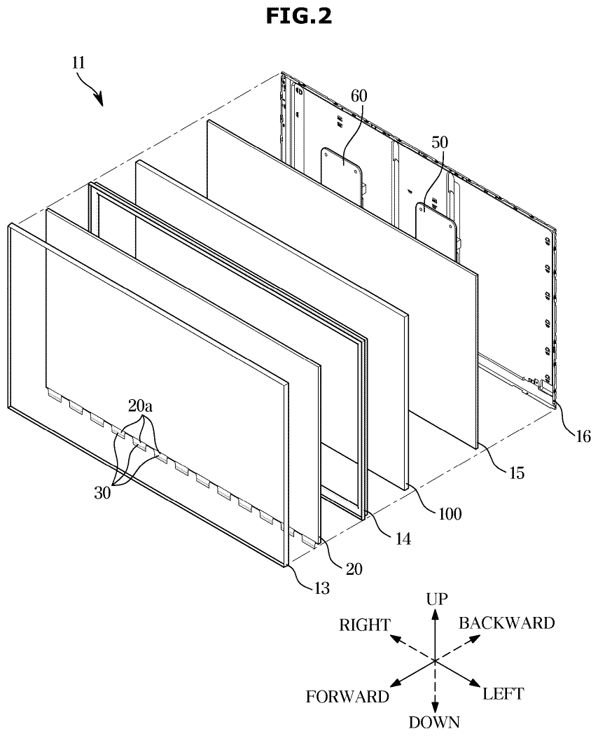

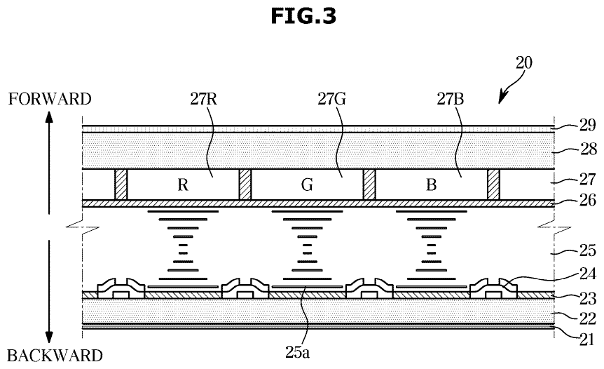

FIG. 2 illustrates an example of a structure of a display apparatus according to one or more embodiments of the disclosure, and FIG. 3 illustrates an example of a liquid crystal panel included in a display apparatus according to one or more embodiments of the disclosure.

As shown in FIG. 2, various components for displaying an image I on the screen S may be installed inside the main body 11.

For example, a backlight unit 100 being a surface light source, a liquid crystal panel 20 for transmitting or blocking light emitted from the backlight unit 100, a control assembly 50 for controlling operations of the backlight unit 100 and the liquid crystal panel 20, and a power assembly 60 for supplying power to the backlight unit 100 and the liquid crystal panel 20 may be provided in the main body 11. Also, the main body 11 may include a bezel 13, a frame middle mold 14, a bottom chassis 15, and a rear cover 16 for supporting the liquid crystal panel 20, the backlight unit 100, the control assembly 50, and the power assembly 60.

The backlight unit 100 may include a point light source for emitting white light. Also, the backlight unit 100 may refract, reflect, and scatter light emitted from the point light source to convert the light into uniform surface light. As such, the backlight unit 100 may emit uniform surface light toward a front direction by refracting, reflecting, and scattering light emitted from the point light source.

The backlight unit 100 will be described in more detail below.

The liquid crystal panel 20 may be positioned in front of the backlight unit 100, and block or transmit light emitted from the backlight unit 100 to form an image I.

A front surface of the liquid crystal panel 20 may form the above-described screen S of the display apparatus 10, and the liquid crystal panel 20 may form the plurality of pixels P. Each of the plurality of pixels P of the liquid crystal panel 20 may independently block or transmit light emitted from the backlight unit 100. Also, light transmitted by the plurality of pixels P may form an image I that is displayed on the screen S.

For example, as shown in FIG. 3, the liquid crystal panel 20 may include a first polarizing film 21, a first transparent substrate 22, a pixel electrode 23, a thin film transistor 24, a liquid crystal layer 25, a common electrode 26, a color filter 27, a second transparent substrate 28, and a second polarizing film 29.

The first transparent substrate 22 and the second transparent substrate 28 may fix and support the pixel electrode 23, the thin film transistor 24, the liquid crystal layer 25, the common electrode 26, and the color filter 27. The first transparent substrate 22 and the second transparent substrate 28 may be made of tempered glass or a transparent resin.

The first polarizing film 21 and the second polarizing film 29 may be respectively positioned on outer surfaces of the first transparent substrate 22 and the second transparent substrate 28. The first polarizing film 21 and the second polarizing film 29 may transmit specific polarized light and block (reflect or absorb) the other polarized light. For example, the first polarizing film 21 may transmit polarized light traveling toward a first direction and block (reflect or absorb) the other polarized light. Also, the second polarizing film 29 may transmit polarized light traveling toward a second direction and block (reflect or absorb) the other polarized light, wherein the second direction may be orthogonal to the first direction. Accordingly, polarized light transmitted by the first polarizing film 21 may not be directly transmitted through the second polarizing film 29.

The color filter 27 may be provided on an inner side of the second transparent substrate 28. The color filter 27 may include, for example, a red filter 27R transmitting red light, a green filter 27G transmitting green light, and a blue filter 27B transmitting blue light. Also, the red filter 27R, the green filter 27G, and the blue filter 28B may be arranged side by side. An area occupied by the color filter 27 may correspond to a pixel P described above. An area occupied by the red filter 27R may correspond to a red sub pixel PR, an area occupied by the green filter 27G may correspond to a green sub pixel PG, and an area occupied by the blue filter 27B may correspond to a blue sub pixel PB.

The pixel electrode 23 may be provided on an inner side of the first transparent substrate 22, and the common electrode 26 may be provided on the inner side of the second transparent substrate 28. The pixel electrode 23 and the common electrode 26 may be made of a metal material carrying electricity, and form an electric field for changing an arrangement of liquid crystal molecules 25a configuring the liquid crystal layer 25 which will be described below.

The thin film transistor 24 may be positioned on the inner surface of the first transparent substrate 22. The thin film transistor 24 may be turned on (closed) or turned off (opened) by image data provided from a panel driver 30. Also, according to turning-on (closing) or turning-off (opening) of the thin film transistor 24, an electric field may be formed or removed between the pixel electrode 23 and the common electrode 26.

The liquid crystal layer 25 may be formed between the pixel electrode 23 and the common electrode 26, and the liquid crystal layer 25 may be filled with the liquid crystal molecules 25a. Liquid crystal is in an intermediate state between a solid (crystal) state and a liquid state. The liquid crystal shows an optical property according to a change in electric field. For example, the direction of the molecular arrangement of liquid crystal changes according to a change in electric field. As a result, the optical property of the liquid crystal layer 25 may change according to the presence/absence of an electric field passing through the liquid crystal layer 25. For example, the liquid crystal layer 25 may rotate a polarizing direction of light with respect to an optical axis according to presence/absence of an electric field. Thereby, a polarizing direction of polarized light that has passed through the first polarizing film 21 may rotate while the polarized light passes through the liquid crystal layer 25, and then the resultant polarized light may pass through the second polarizing film 29.

At one edge of the liquid crystal panel 20, a cable 20a for transmitting image data to the liquid crystal panel 20, and a display driver integrated circuit (DDI) (hereinafter, referred to as a ‘panel driver’) 30 for processing digital image data and outputting an analog image signal may be provided.

The cable 20a may electrically connect the control assembly 50/power assembly 60 to the panel driver 30, and also electrically connect the panel driver 30 to the liquid crystal panel 20. The cable 20a may include a flexible flat cable or a film cable.

The panel driver 30 may receive image data and power from the control assembly 50/power assembly 60 through the cable 20a. Also, the panel driver 30 may provide image data and driving current to the liquid crystal panel 20 through the cable 20a.

Also, the cable 20a and the panel driver 30 may be integrally provided and implemented as a film cable, a chip on film (COF), a tape carrier package (TCP), etc. In other words, the panel driver 30 may be positioned on the cable 20a, although not limited thereto. However, the panel driver 30 may be positioned on the liquid crystal panel 20.

The control assembly 50 may include a control circuit for controlling operations of the liquid crystal panel 20 and the backlight unit 100. For example, the control circuit may process a video signal and/or an audio signal received from an external content source. The control circuit may transmit image data to the liquid crystal panel 20 and transmit dimming data to the backlight unit 100.

The power assembly 60 may include a power circuit for supplying power to the liquid crystal panel 20 and the backlight unit 100. The power circuit may supply power to the control assembly 50, the backlight unit 100, and the liquid crystal panel 20.

The control assembly 50 and the power assembly 60 may be implemented with a printed circuit board and various kinds of circuits mounted on the printed circuit board. For example, the power circuit may include a capacitor, a coil, a resistor device, a processor, and a power circuit board on which the capacitor, the coil, the resistor device, and the processor are mounted. Also, the control circuit may include a memory, a processor, and a control circuit board on which the memory and the processor are mounted.

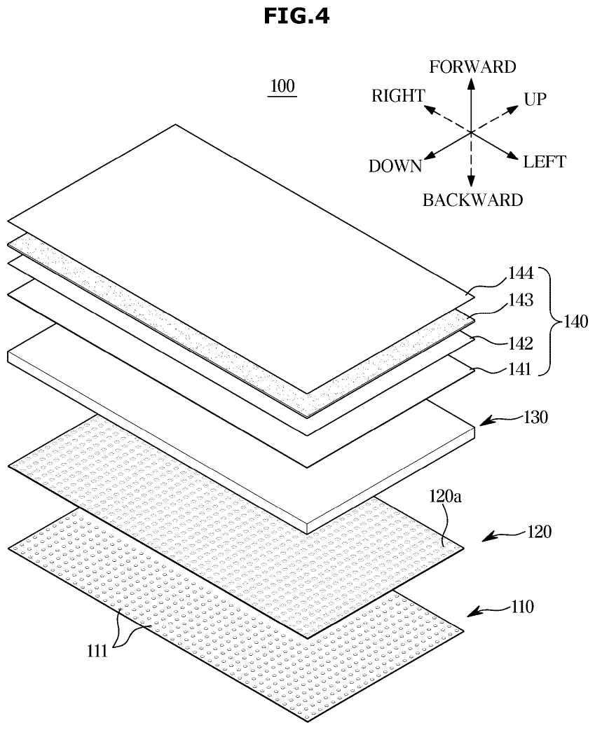

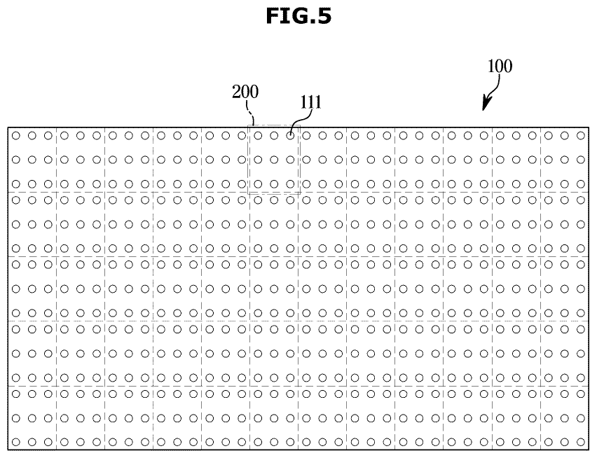

FIG. 4 illustrates an example of a backlight unit (BLU) included in a display apparatus according to one or more embodiments of the disclosure, and FIG. 5 is a diagram illustrating that a plurality of light emitting diodes of a backlight unit are divided into dimming blocks according to one or more embodiments of the disclosure.

As shown in FIG. 4, the backlight unit 100 may include a light source module 110 for generating light, a reflective sheet 120 for reflecting light, a diffuser plate 130 for uniformly diffusing light, and an optical sheet 140 for improving luminance of exit light.

The light source module 110 may include a plurality of light emitting devices 111 for emitting light, and a substrate 112 for supporting/fixing the plurality of light emitting devices 111.

The plurality of light emitting devices 111 may be arranged in a preset pattern to emit light with uniform luminance. The plurality of light emitting devices 111 may be arranged such that distances between each light emitting device and the neighboring light emitting devices are the same.

For example, as shown in FIG. 4, the plurality of light emitting devices 111 may be arranged in regular rows and columns. For example, the plurality of light emitting devices 111 may be arranged such that four neighboring light emitting devices form substantially a square. Also, any one light emitting device may be adjacent to four light emitting devices, and distances between the light emitting device and the four adjacent light emitting devices may be substantially the same.

Also, according to some embodiments, the plurality of light emitting devices 111 may be arranged such that three neighboring light emitting devices form substantially an equilateral triangle. In this case, one light emitting device may be adjacent to six light emitting devices, and distances between the light emitting device and the six adjacent light emitting devices may be substantially the same.

However, an arrangement of the plurality of light emitting devices 111 is not limited to the above-described arrangement, and the plurality of light emitting devices 111 may be arranged in various ways to emit light with uniform luminance.

Each light emitting device 111 may employ a device capable of emitting, upon receiving power, monochromatic light (light having a specific wavelength, for example, blue light) or white light (for example, mixed light of red light, green light, and blue light) in various directions. For example, the light emitting device 111 may include a LED. The LED may have various sizes, and for example, the LED may include a mini LED and/or a micro LED.

The substrate 112 may fix the plurality of light emitting devices 111 to prevent the light emitting devices 111 from moving. Also, the substrate 112 may supply power for enabling the light emitting devices 111 to emit light to the individual light emitting devices 111.

The substrate 112 may include a synthetic resin and/or tempered glass and/or a printed circuit board (PCB), on which a conductive power supply line for fixing the plurality of light emitting devices 111 and supplying power to the light emitting devices 111 is formed.

The reflective sheet 120 may reflect light emitted from the plurality of light emitting devices 111 toward the front direction or toward an approximately front direction.

In the reflective sheet 120, a plurality of through holes 120a may be formed at locations respectively corresponding to the plurality of light emitting devices 111 of the light source module 110. Also, the light emitting devices 111 of the light source module 110 may pass through the through holes 120a, and protrude forward from the reflective sheet 120.

For example, during an assembly process of the reflective sheet 120 and the light source module 110, the plurality of light emitting devices 111 of the light source module 110 may be inserted into the plurality of through holes 120a formed in the reflective sheet 120. Therefore, although the substrate 112 of the light source module 110 is located behind the reflective sheet 120, the plurality of light emitting devices 111 of the light source module 110 may be located in front of the reflective sheet 120.

Accordingly, the plurality of light emitting devices 111 may emit light in front of the reflective sheet 120.

The plurality of light emitting devices 111 may emit light in various directions in front of the reflective sheet 120. Light may be emitted toward the diffuser plate 130 from the light emitting devices 111 and toward the reflective sheet 120 from the light emitting devices 111. The reflective sheet 120 may reflect light emitted toward the reflective sheet 120 toward the diffuser plate 130.

Light emitted from the light emitting devices 111 may pass through various objects, such as the diffuser plate 130, the optical sheet 140, etc. While light passes through the diffuser plate 130 and the optical sheet 140, a part of the light may be reflected from surfaces of the diffuser plate 130 and the optical sheet 140. The reflective sheet 120 may reflect light reflected by the diffuser plate 130 and the optical sheet 140.

The diffuser plate 130 may be provided in front of the light source module 110 and the reflective sheet 120 and may uniformly disperse light emitted from the light emitting devices 111 of the light source module 110.

The plurality of light emitting devices 111 may be positioned at a plurality of locations in a rear portion of the backlight unit 100, as described above. Although the plurality of light emitting devices 111 are arranged at equidistant intervals in the rear portion of the backlight unit 100, luminance non-uniformity may occur according to the locations of the plurality of light emitting devices 111.

The diffuser plate 130 may diffuse light emitted from the plurality of light emitting devices 111 in the inside to remove luminance non-uniformity caused by the plurality of light emitting devices 111. In other words, the diffuser plate 130 may uniformly emit non-uniform light emitted from the plurality of light emitting device 111 through the front surface.

The optical sheet 140 may include various sheets for improving luminance and uniformity of luminance. For example, the optical sheet 140 may include a diffuser sheet 141, a first prism sheet 142, a second prism sheet 143, and a reflective polarizing sheet 144.

The diffuser sheet 141 may diffuse light for luminance uniformity. Light emitted from the light emitting devices 111 may be diffused by the diffuser plate 130 and then diffused again by the diffuser sheet 141 included in the optical sheet 140.

The first prism sheet 142 and the second prism sheet 143 may concentrate the light diffused by the diffusing sheet 141 to increase luminance. The first prism sheet 142 and the second prism sheet 143 may include a prism pattern being in a shape of a trigonal prism, and a plurality of prism patterns may be arranged adjacent to each other, thereby forming a plurality of bands.

The reflective polarizing sheet 144 may be a kind of a polarizing film to transmit a part of incident light and reflect the other part of the incident light to improve luminance. For example, the reflective polarizing sheet 144 may transmit polarized light traveling in a preset polarization direction of the reflective polarizing sheet 144 and reflect polarized light traveling in a polarization direction that is different from the preset polarization direction of the reflective polarizing sheet 144. Also, light reflected by the reflective polarizing sheet 144 may be recycled inside the backlight unit 100, and luminance of the display apparatus 10 may be improved by such light recycle.

The optical sheet 140 is not limited to the sheets or films shown in FIG. 4, and may include various sheets or films, such as a protection sheet, etc.

The backlight unit 100 may include the plurality of light emitting devices 111, and diffuse light emitted from the plurality of light emitting devices 111 to output surface light. The liquid crystal panel 20 may include a plurality of pixels, and control each of the plurality of pixels to transmit or block light. An image may be formed by light that has passed through each of the plurality of pixels.

In this instance, the display apparatus 10 may perform local dimming to vary brightness of light for each area of the backlight unit 100 in conjunction with an output image to improve power consumption while increasing a contrast ratio.

For example, the display apparatus 10 may decrease brightness of light emitted from light emitting devices 111 of the backlight unit 100 corresponding to a dark area of an image to make the dark area darker, and to make a bright area of the image brighter, the display apparatus 10 may increase brightness of light emitted from light emitting devices 111 of the backlight unit 100 corresponding to the bright area of the image. Therefore, a contrast ratio or brightness ratio of the image may be improved.

The display apparatus 10 may divide the backlight unit 100 into a plurality of blocks and adjust current independently for each block according to an input image. Image transmission of the display apparatus 10 may be performed through frame-based local dimming driving, and driving of current may be controlled according to the number of blocks of the light emitting devices 111 in the backlight unit 100.

As a result, the display apparatus 10 may supply less current to dimming blocks corresponding to a dark area of an input image and supply more current to dimming blocks corresponding to a bright area of the image, thereby effectively improving a contrast ratio.

For local dimming, the plurality of light emitting devices 111 included in the backlight unit 100 may be divided into a plurality of dimming blocks 2000. For example, the plurality of dimming blocks 200 may be arranged in five rows and twelve columns, totaling 60 dimming blocks, as shown in FIG. 5. As another example, the plurality of dimming blocks 200 may be arranged in five rows and four columns, totaling 20 dimming blocks. However, the number of the dimming blocks 200 is not limited to these examples.

Referring to FIG. 5, each of the plurality of dimming blocks 200 may include one or more light emitting devices 111. The backlight unit 100 may supply the same driving current to the light emitting devices 111 belonging to the same dimming block 200, and the light emitting devices 111 belonging to the same dimming block 200 may emit light having the same brightness.

Also, the backlight unit 100 may supply different driving current to light emitting devices 111 belonging to different dimming blocks 200 according to dimming data, and the light emitting devices 111 belonging to the different dimming blocks 200 may emit light having different brightness.

For example, each of the plurality of dimming blocks 200 may include N*M light sources arranged in a N*M matrix form (N and M are natural numbers). The N*M matrix may be a matrix having N rows and M columns.

Because each of the light emitting devices 111 includes a LED, each of the plurality of dimming blocks 200 may include N*M LEDs. That is, each of the plurality of dimming blocks 200 may include a preset number of light emitting devices 111.

The plurality of dimming blocks 200 may be positioned on the substrate 112. That is, the N*M LEDs may be positioned on the substrate 112.

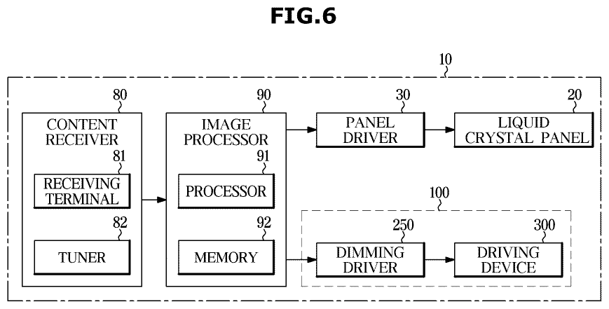

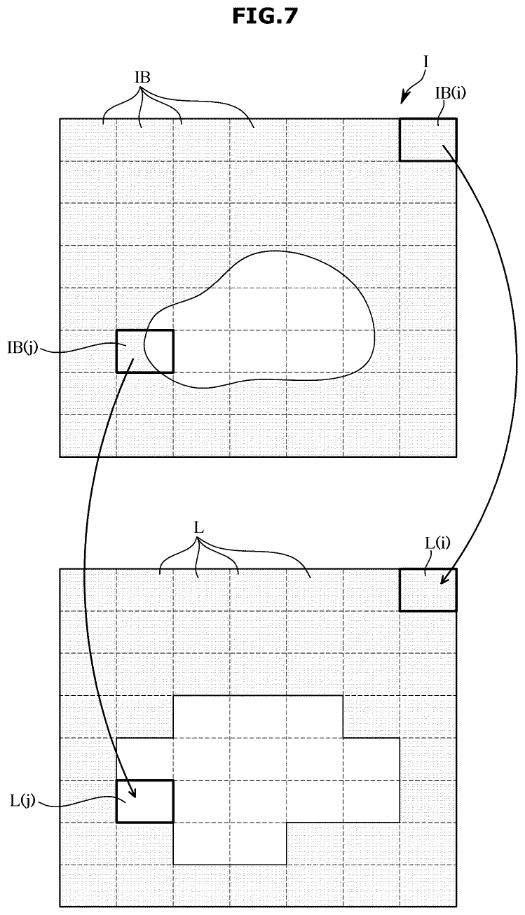

FIG. 6 is a control block diagram of a display apparatus according to one or more embodiments of the disclosure, and FIG. 7 illustrates an example of converting image data into dimming data, performed by a display apparatus according to one or more embodiments of the disclosure.

Referring to FIG. 6, the display apparatus 10 may include a content receiver 80, an image processor 90, the panel driver 30, the liquid crystal panel 20, and the backlight unit 100. In this case, the backlight unit 100 may include a dimming driver 250 that performs local dimming, and a driving device 300 that drives the light emitting devices 111. The driving device 300 may be positioned on an upper or lower surface of the substrate 112.

The content receiver 80 may include a receiving terminal 81 for receiving a video signal and/or an audio signal from content sources, and a tuner 82.

The receiving terminal 81 may receive a video signal and an audio signal from the content sources through a cable. For example, the receiving terminal 81 may include a component (YPbPr/RGB) terminal, a composite video blanking and sync (CVBS) terminal, an audio terminal, a high definition multimedia interface (HDMI) terminal, a universal serial bus (USB) terminal, etc.

The tuner 82 may receive broadcasting signals from a broadcasting reception antenna or a wired cable, and extract a broadcasting signal of a channel selected by a user from among the broadcasting signals. For example, the tuner 82 may pass a broadcasting signal having a frequency corresponding to a channel selected by a user among a plurality of broadcasting signals received through the broadcasting reception antenna or the wired cable, and block broadcasting signals having the other frequencies.

As such, the content receiver 80 may receive an image including a video signal and an audio signal from the content sources through the receiving terminal 81 and/or the tuner 82, and output the image received through the receiving terminal 81 and/or the tuner 82 to the image processor 90.

The image processor 90 may include at least one processor 91 that processes an input image (image data) and memory 92 that memories/stores data.

The memory 92 may store a program (instructions) and data for processing a video signal and/or an audio signal, and temporarily memorize data generated while processing the video signal and/or the audio signal.

The memory 92 may include a non-volatile memory, such as read only memory (ROM) and a flash memory, and a volatile memory, such as static random access memory (S-RAM) and dynamic random access memory (D-RAM).

The at least one processor 91 may receive an input image including a video signal and/or an audio signal from the content receiver 80, decode the video signal to generate image data, and generate dimming data from the image data. The image data and the dimming data may be output to the panel driver 30 and the dimming driver 250.

The at least one processor 91 may provide dimming data for local dimming to the backlight unit 100. The dimming data may include information about luminance of each of the plurality of dimming blocks 200. For example, the dimming data may include information about an intensity of light output from the light emitting devices 111 included in each of the plurality of dimming blocks 200. That is, the dimming data may include information about a magnitude of current that is supplied to the light emitting devices 111 included in each of the plurality of dimming blocks 200.

The at least one processor 91 may obtain the dimming data from the image data decoded from the video signal.

The processor 91 may convert image data into dimming data by various methods. For example, as shown in FIG. 7, the processor 91 may divide an image I formed by image data into a plurality of image blocks IB. The number of the plurality of image blocks IB may be equal to the number of the plurality of dimming blocks 200, and the plurality of image blocks IB may respectively correspond to the plurality of dimming blocks 200.

The processor 91 may obtain luminance values L of the plurality of dimming blocks 200 from image data of the plurality of image blocks IB. Also, the processor 91 may generate dimming data by combining the luminance values L of the plurality of dimming blocks 200.

For example, the processor 91 may obtain a luminance value L of each of the plurality of dimming blocks 200 based on a maximum value of luminance values of pixels included in each of the image blocks IB.

An image block may include a plurality of pixels, and image data of the image block may include image data (for example, red data, green data, blue data, etc.) of the plurality of pixels. The processor 91 may calculate a luminance value of each pixel based on image data of the pixel.

The processor 91 may set a maximum value of luminance values of pixels included in an image block to a luminance value of a dimming block corresponding to the image block. For example, the processor 91 may set a maximum value of luminance values of pixels included in an i-th image block IB(i) to a luminance value L(i) of an i-th dimming block, and set a maximum value of luminance values of pixels included in a j-th image block IB(j) to a luminance value L(j) of a j-th dimming block.

The processor 91 may generate dimming data by combining luminance values of the plurality of dimming blocks 200.

As such, the image processor 90 may decode a video signal obtained by the content receiver 80 to generate image data and generate dimming data from the image data. Also, the image processor 90 may transmit the image data and the dimming data to the liquid crystal panel 20 and the backlight unit 100 (light source device), respectively.

The liquid crystal panel 20 may include a plurality of pixels capable of transmitting or blocking light, and the plurality of pixels may be arranged in a matrix form. In other words, the plurality of pixels may be arranged in a plurality of rows and a plurality of columns.

The panel driver 30 may receive image data from the image processor 90 and drive the liquid crystal panel 20 according to the image data. In other words, the panel driver 30 may convert image data (hereinafter, referred to as ‘digital image data’) which is a digital signal into an analog image signal which is an analog voltage signal, and provide the converted analog image signal to the liquid crystal panel 20. Optical properties (for example, light transmittance) of the plurality of pixels included in the liquid crystal panel 20 may change according to the analog image signal.

The panel driver 30 may include, for example, a timing controller, a data driver, a scan driver, etc.

The timing controller may receive image data from the image processor 90 and output the image data and a driving control signal to the data driver and the scan driver. The driving control signal may include a scan control signal and a data control signal, and the scan control signal and the data control signal may be used to respectively control an operation of the scan driver and an operation of the data driver.

The scan driver may receive a scan control signal from the timing controller and input-activate any one of the plurality of rows in the liquid crystal panel 20 according to the scan control signal. In other words, the scan driver may convert pixels included in any row among the plurality of pixels arranged in the plurality of rows and the plurality of columns to a state capable of receiving an analog image signal. At this time, the other pixels input-deactivated, except for the pixels input-activated by the scan driver, may not receive an analog image signal.

The data driver may receive image data and a data control signal from the timing controller and output the image data to the liquid crystal panel 20 according to the data control signal. For example, the data driver may receive digital image data from the timing controller and convert the digital image data into an analog image signal. Also, the data driver may provide the analog image signal to pixels included in any row input-activated by the scan driver. At this time, the pixels input-activated by the scan driver may receive the analog image signal and optical properties (for example, light transmittance) of the input-activated pixels may change according to the received analog image signal.

As such, the panel driver 30 may drive the liquid crystal panel 20 according to the image data. Therefore, an image corresponding to the image data may be displayed on the liquid crystal panel 20.

The backlight unit 100 (light source device) may include the plurality of light emitting devices 111 (light source) that emit light, and the plurality of light emitting devices 111 may be arranged in a matrix form. In other words, the plurality of light emitting devices 111 may be arranged in a plurality of rows and a plurality of columns. Also, the light emitting devices 111 may be divided into a plurality of dimming blocks 200, and each of the plurality of dimming blocks 200 may include at least one light emitting device 111.

The dimming driver 250 may receive dimming data from the image processor 90 and drive the backlight unit 100 according to the dimming data. The dimming data may include information about luminance of each of the plurality of dimming blocks 200 or information about brightness of light emitting devices 111 included in each of the plurality of dimming blocks 200.

The dimming driver 250 may convert dimming data (hereinafter, referred to as ‘digital dimming data’) which is a digital signal, into an analog dimming signal which is an analog voltage signal, and provide the analog dimming signal to the backlight unit 100. An intensity of light emitted from the light emitting devices 111 included in each of the plurality of dimming blocks 200 may change according to the analog dimming signal.

Particularly, the dimming driver 250 may provide the analog dimming signal sequentially to the plurality of dimming blocks 200 by an active matrix method, instead of directly providing the analog dimming signal to all of the plurality of dimming blocks 200.

As described above, the plurality of dimming blocks 200 may be arranged in a matrix form in the backlight unit 100. In other words, the plurality of dimming blocks 200 may be arranged in a plurality of rows and a plurality of columns in the backlight unit 100.

The dimming driver 250 may provide the analog dimming signal sequentially to dimming blocks belonging to the plurality of rows or to dimming blocks belonging to the plurality of columns.

For example, the dimming driver 250 may input-activate dimming blocks belonging to any row of the plurality of dimming blocks 200 and provide the analog dimming signal to the input-activated dimming blocks. Then, the dimming driver 250 may input-activate dimming block belonging to another row of the plurality of dimming blocks 200 and provide the analog dimming signal to the input-activated dimming blocks.

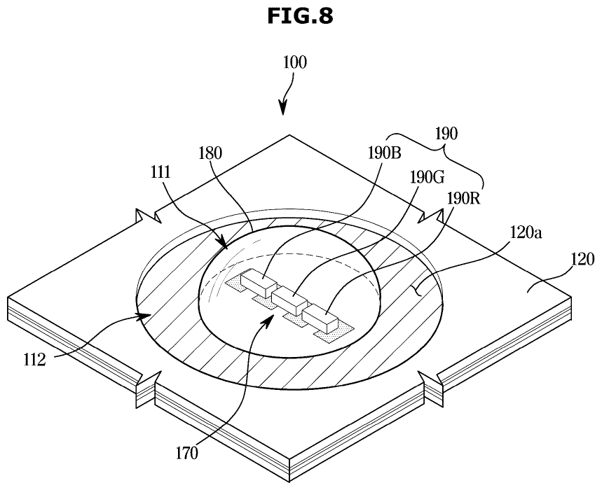

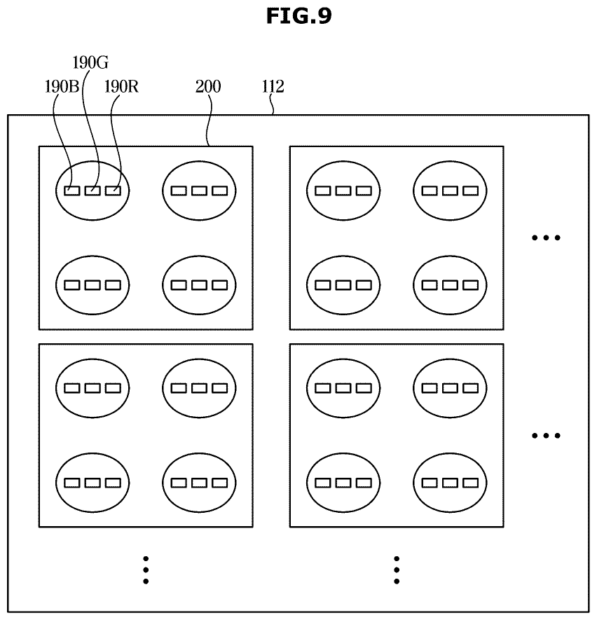

FIG. 8 shows an example of a light emitting device included in a backlight unit according to an embodiment, and FIG. 9 illustrates a plurality of local dimming blocks according to an embodiment.

Each light emitting device 111 may include one LED group 170. That is, each light emitting device 111 may include a red LED 190R, a green LED 190G, and a blue LED 190B, as shown in FIG. 8.

A plurality of LED groups 170 may be arranged in a two-dimensional matrix form on an upper surface of the substrate 112. That is, as shown in FIG. 4, because the plurality of light emitting devices 111 are arranged in rows and columns, the plurality of LED groups 170 may be arranged in a two-dimensional matrix form.

Also, according to some embodiments, the plurality of light emitting devices 111 may be arranged such that three neighboring light emitting devices form substantially an equilateral triangle. In this case, one light emitting device may be adjacent to six light emitting devices. Also, distances between the light emitting device and the six adjacent light emitting devices may be substantially the same.

However, an arrangement of the plurality of light emitting devices 111 is not limited to the above-described arrangement, and the plurality of light emitting devices 111 may be arranged in various ways to emit light with uniform luminance.

The light emitting device 111 may employ a device capable of emitting white light (light having a plurality of peak wavelengths, for example, light mixed with red light, green light, and blue light) in various directions when power is supplied.

That is, each light emitting device 111 may emit white light by including the red LED 190R, the green LED 190G, and the blue LED 190B.

As shown in FIG. 8, each of the plurality of light emitting devices 111 may include the LED group 170 and an optical dome 180.

The thickness of the backlight unit 100 may be reduced so that the thickness of the display apparatus 10 is reduced. Each of the plurality of light emitting devices 111 is thinned and its structure is simplified so that the thickness of the backlight unit 100 is reduced.

The red LED 190R, the green LED 190G, and the blue LED 190B of the LED group 170 may be directly attached to the substrate 112 by a chip on board (COB) method. For example, the light emitting device 111 may include an LED 190 formed by attaching an LED chip or an LED die directly to the substrate 112 without separate packaging.

The LED 190 may be manufactured in a flip chip type. The LED 190 of the flip chip type may be formed by welding, upon attaching an LED being a semiconductor device to the substrate 112, an electrode pattern of a semiconductor device as it is to the substrate 112 without using a middle medium, such as a metal lead (wire) or a ball grid array (BGA). As such, by using neither a metal lead (wire) nor a ball grid array, the light emitting device 111 including the LED 190 of the flip chip type may be miniaturized.

Although the LED 190 of the flip chip type welded directly to the substrate 112 by the chip on board method has been described above, the light emitting devices 111 are not limited to an LED of a flip chip type. For example, the light emitting device 111 may include an LED of a package type.

The optical dome 180 may cover the LED group 170. That is, the optical dome 180 may cover the red LED 190R, the green LED 190G, and the blue LED 190B included in the LED group 170.

The optical dome 180 refract red light, green light, and blue light respectively emitted from the red LED 190R, the green LED 190G, and the blue LED 190B to mix the red light, green light, and blue light, thereby emitting white light.

As such, the optical dome 180 may emit white light by mixing red light, green light, and blue light, and reduce a distance required for mixing to white light, compared to a case in which no optical dome 180 exists, thereby reducing an optical distance OD required for changing point light sources to a surface light source.

Also, the optical dome 180 may prevent or suppress the LEDs 190 from being damaged by a mechanical action from outside and/or by a chemical action.

The optical dome 180 may be in a shape of a dome resulting from cutting, for example, a sphere with a plane not including a center of the sphere, or in a shape of a hemisphere resulting from cutting a sphere with a plane including a center of the sphere. A vertical section of the optical dome 180 may be in a shape of, for example, a segment of a circle or a semicircle.

The optical dome 180 may be formed of silicon or an epoxy resin. For example, the optical dome 180 may be formed by discharging molten silicon or a molten epoxy resin onto the LEDs 190 through a nozzle, etc. and then hardening the silicon or epoxy resin.

The optical dome 180 may be optically transparent or translucent. Light emitted from the LED 190 may pass through the optical dome 180 and be emitted to the outside.

At this time, the dome-shaped optical dome 180 may refract light like a lens. For example, light emitted from the LEDs 190 may be refracted by the optical dome 180 and dispersed.

As such, the optical dome 180 may protect the LEDs 190 from an external mechanical and/or chemical action or an electrical action, and disperse light emitted from the LEDs 190.

Although the optical dome 180 in the form of a silicone dome has been described above, the light emitting devices 111 are not limited to including the optical dome 180. For example, the light emitting device 111 may include a lens for dispersing light emitted from the light emitting diodes.

As described above, for local dimming, the plurality of light emitting devices 111 included in the backlight unit 100 may be divided into a plurality of dimming blocks 200.

Accordingly, as shown in FIG. 9, four light emitting devices 111, each of which includes the red LED 190R, the green LED 190G, and the blue LED 190B, form one dimming block 200, and the plurality of dimming blocks 200 may be arranged in a two-dimensional matrix form. One dimming block 200 may include various numbers of light emitting devices 111.

As such, because each light emitting device 111 includes the red LED 190R, the green LED 190G, and the blue LED 190B, the disclosure may achieve higher color purity, a higher contrast ratio, and higher image quality, than in local dimming using single light.

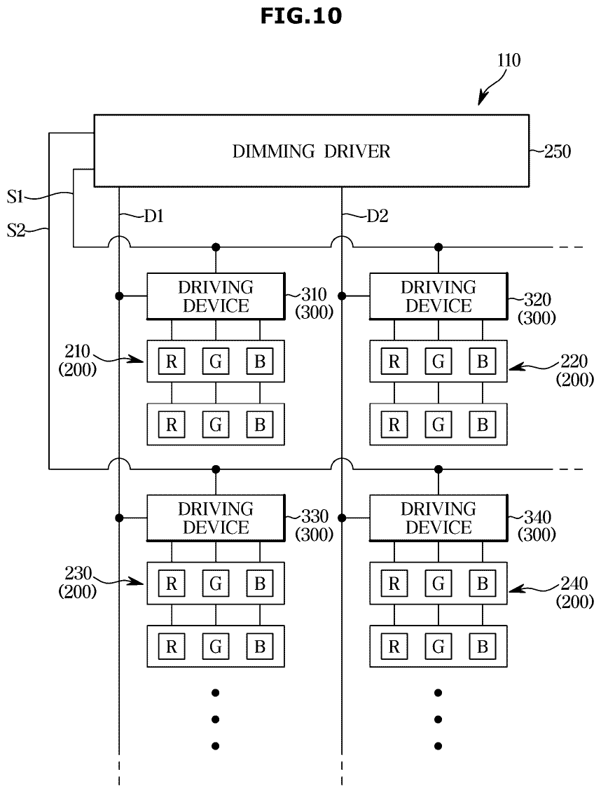

FIG. 10 illustrates an arrangement of a dimming driver, driving devices, and light emitting devices included in a display apparatus according to one or more embodiments of the disclosure.

Each of the plurality of light emitting devices (the plurality of light sources) may include LEDs and may be divided into the plurality of dimming blocks 200. A plurality of light emitting devices belonging to the same dimming block may form a group.

The plurality of driving devices 300 may receive an analog dimming signal from the dimming driver 250 and supply driving current to the plurality of light emitting devices according to the received analog dimming signal.

Each of the plurality of driving devices 300 may supply driving current to the plurality of light emitting devices included in not only one dimming block 200 but also at least two dimming blocks 200.

As shown in FIG. 10, a plurality of light emitting devices belonging to one dimming block may receive current from the same driving device. For example, a plurality of light sources belonging to a first dimming block 210 may receive driving current from a first driving device 310. A plurality of light emitting devices belonging to a second dimming block 220 may receive driving current from a second driving device 320. A plurality of light emitting devices belonging to a third dimming block 230 may receive driving current from a third driving device 330. A plurality of light emitting devices belonging to a fourth dimming block 240 may receive driving current from a fourth driving device 340. In the same manner, a plurality of light emitting devices belonging to a n-th dimming block may receive driving current from a n-th driving device.

Accordingly, a plurality of light emitting devices belonging to one dimming block may receive driving current of the same magnitude. In addition, a plurality of light emitting devices belonging to one dimming block may emit light of the same intensity.

Also, according to the disclosure, a plurality of light emitting devices 111 belonging to one dimming block 200 may include the red LED 190R, the green LED 190G, and the blue LED 190B as described above, and in this case, LEDs of the same color may receive current from a driving device along the same current supply line.

That is, each of the plurality of driving devices may include a plurality of current supply lines for supplying driving current, and the current supply lines may be arranged to supply driving current to LEDs of the same color.

That is, as shown in FIG. 10, one current supply line extending from a driving device may be connected only to red LEDs, only to green LEDs, or only to blue LEDs.

While the driving devices 300 are input-activated by the dimming driver 250, the driving devices 300 may receive an analog dimming signal from the dimming driver 250 and store the received analog dimming signal. Also, while the driving devices 300 are input-deactivated, the plurality of driving devices 300 may supply driving current corresponding to the stored analog dimming signal to the plurality of light emitting devices.

A plurality of scan lines, such as a first scan line S1 and a second scan line S2, for providing a scan signal from the dimming driver 250 to the plurality of driving devices 300 and a plurality of data lines, such as a first data line D1 and a second data line D2, for providing an analog dimming signal from the dimming driver 250 to the plurality of driving devices 300 may be provided.

The plurality of dimming blocks 200 may be arranged in a plurality of rows and a plurality of columns. Driving devices that supply driving current to light emitting devices of dimming blocks belonging to the same row may share the same scan line. For example, the first driving device 310 and the second driving device 320 may share the first scan line S1, and the third driving device 330 and the fourth driving device 340 may share the second scan line S2.

In addition, driving devices that supply driving current to light emitting devices of dimming blocks belonging to the same column may share the same data line. For example, the first driving device 310 and the third driving device 330 may share the first data line D1, and the second driving device 320 and the fourth driving device 340 may share the second data line D2.

The plurality of driving devices 300 may be input-activated by a scan signal from the dimming driver 250 and may receive an analog dimming signal from the dimming driver 250.

For example, while the dimming driver 250 outputs a scan signal through the first scan line S1, the first driving device 310 and the second driving device 320 may receive an analog dimming signal through the first data line D1 and the second data line D2. The third driving device 330 and the fourth driving device 340 may receive no analog dimming signal.

In addition, while the dimming driver 250 outputs a scan signal through the second scan line S2, the third driving device 330 and the fourth driving device 340 may receive an analog dimming signal through the first data line D1 and the second data line D2. The first driving device 310 and the second driving device 320 may receive no analog dimming signal.

When the plurality of driving devices 300 receive analog dimming signals, the plurality of driving devices 300 may store the received analog dimming signals and supply driving current to the plurality of light emitting devices according to the stored analog dimming signals.

For example, while the dimming driver 250 outputs a scan signal through the first scan line S1, the third driving device 330 and the fourth driving device 340 may supply driving current to a plurality of light emitting devices included in the third dimming block 230 and the fourth dimming block 240.

In addition, while the dimming driver 250 outputs a scan signal through the second scan line S2, the first driving device 310 and the second driving device 320 may supply driving current to a plurality of light emitting devices included in the first dimming block 210 and the second dimming block 220.

By such driving based on the active-matrix method, the plurality of driving devices 300 may receive an analog dimming signal sequentially from the dimming driver 250, and, even while the plurality of driving devices 300 are input-deactivated by receiving no analog dimming signal from the dimming driver 250, the plurality of driving devices 300 may supply driving current to the plurality of light emitting devices.

In addition, by the driving based on the active-matrix method, the number of pins of the dimming driver 250 for providing an analog dimming signal to the plurality of dimming blocks 200 may be reduced. Also, the number of signal lines for providing an analog dimming signal from the dimming driver 250 to the plurality of dimming blocks 200 may be reduced. Therefore, the number of dimming blocks may increase regardless of the number of the pins of the dimming driver 250.

The structure and connection relationships of local dimming blocks including red LEDs, green LEDs, and blue LEDs have been described. Hereinafter, dividing each of the LEDs into a plurality of cells is described.

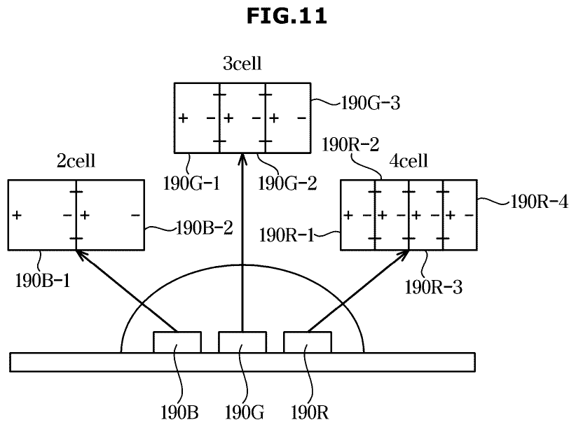

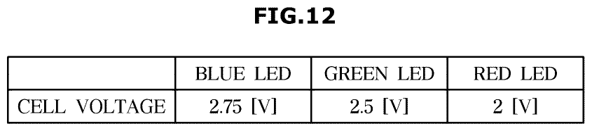

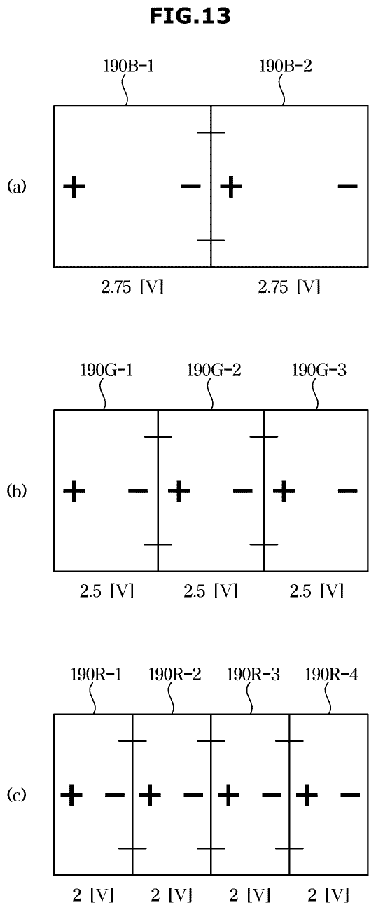

FIG. 11 illustrates that each light emitting device is divided into a plurality of cells according to one or more embodiments of the disclosure, FIG. 12 illustrates a cell voltage of each light emitting device according to one or more embodiments of the disclosure, and FIG. 13 illustrates connection relationships of a plurality of cells of each light emitting device according to one or more embodiments of the disclosure.

In a case where a local dimming system is implemented in a red/green/blue LED-based LED backlight, a block common voltage may be used or red/green/blue block voltages may be used separately. When using a block common voltage, luminous efficiency may be reduced due to different block voltages for each color LED.

Accordingly, the red LED 190R, the green LED 190G, and the blue LED 190B included in each of the plurality of dimming blocks 200 of the display apparatus 10 according to one or more embodiments of the disclosure may be divided into different numbers of LED cells.

For example, the blue LED 190B may be divided into two LED cells 190B-1 and 190B-2, the green LED 190G may be divided into three LED cells 190G-1, 190G-2, and 190G-3, and the red LED 190R may be divided into four LED cells 190R-1, 190R-2, 190R-3, and 190R-4.

Because the blue LED 190B may have the highest cell voltage, the green LED 190G may have the second highest cell voltage, and the red LED 190R may have the lowest cell voltage, the blue LED 190B may be divided into the smallest number of LED cells and the red LED 190R may be divided into the largest number of LED cells to make the block voltages of LEDs of each color similar.

To this end, the number of divided LED cells of the red LED 190R may be greater than that of the green LED 190G, and the number of divided LED cells of the green LED 190G may be greater than that of the blue LED 190B.

In addition, the number of LED cells of the red LED 190R may be less than the sum of the number of LED cells of the green LED 190G and the number of LED cells of the blue LED 190B.

That is, the red LED 190R having the lowest cell voltage may be divided into the largest number of LED cells, but the number of LED cells of the red LED 190R may be less than the sum of LED cells of the green LED 190G and the blue LED 190B.

For example, the blue LED 190B may be divided into two LED cells 190B-1 and 190B-2, the green LED 190G may be divided into three LED cells 190G-1, 190G-2, and 190G-3, and the red LED 190R may be divided into four LED cells 190R-1, 190R-2, 190R-3, and 190R-4. However, the number of divided LED cells of each color LED is merely an example, and may be divided into various numbers of LED cells to make block voltages similar. Even when red/green/blue block voltages are separated, the design complexity of the power assembly 60 may be reduced by making red/green/blue block voltages to be closely matched.

As shown in FIG. 12, the cell voltage of the blue LED 190B may be 2.75 [V], the cell voltage of the green LED 190G may be 2.5 [V], and the cell voltage of the red LED 190R may be 2 [V].

Each divided LED cell may be connected in series through internal bridges. Accordingly, as shown in FIG. 13(a), the blue LED 190B may have a block voltage of 5.5 [V] by being divided into two LED cells, each having a cell voltage of 2.75 [V]. In addition, as shown in FIG. 13(b), the green LED 190G may have a block voltage of 7.5 [V] by being divided into three LED cells, each having a cell voltage of 2.5 [V]. As shown in FIG. 13(c), the red LED 190R may have a block voltage of 8 [V] by being divided into four LED cells each having a cell voltage of 2 [V].

As such, because LEDs of each color may have different cell voltages according to the characteristics of LEDs of each color, driving efficiency may be increased by dividing LEDs into different numbers of LED cells for each color to make block voltages similar.

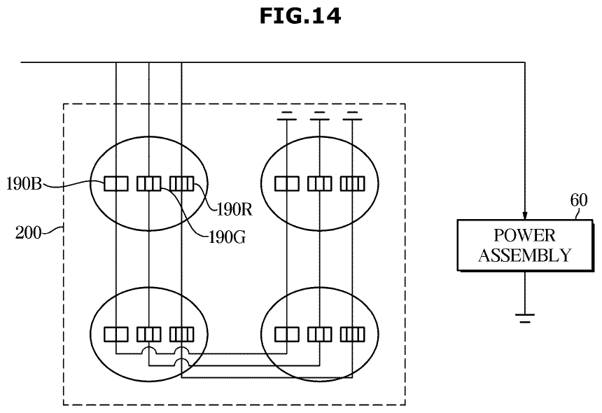

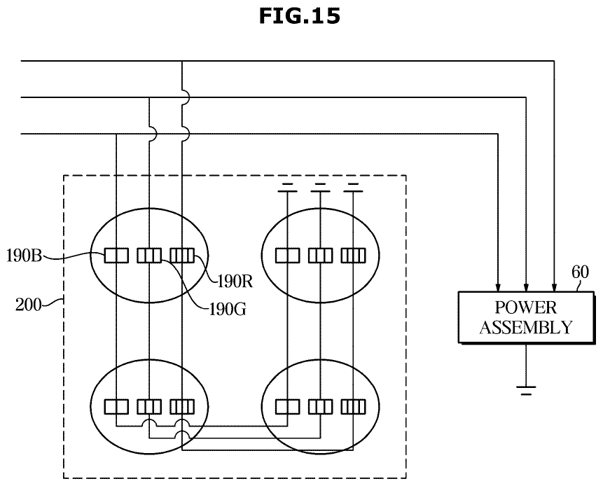

FIG. 14 and FIG. 15 illustrate connection wiring between a driving device and each light emitting device according to one or more embodiments of the disclosure.

As described above, the plurality of light emitting devices 111 belonging to one dimming block 200 may include the red LED 190R, the green LED 190G, and the blue LED 190B, and in this case, LEDs of the same color may receive current from a driving device along the same current supply line.

That is, each of the plurality of driving devices may include a plurality of current supply lines for supplying driving current, and the current supply lines may be arranged to supply driving current to LEDs of the same color.

That is, as shown in FIG. 10, FIG. 14, and FIG. 15, one current supply line extending from a driving device may be connected only to red LEDs, only to green LEDs, or only to blue LEDs.

At this time, because LEDs of each color may each be divided into at least two LED cells, current flowing to each LED cell may be reduced. Accordingly, driving efficiency may be increased as LED cells are driven with relatively low current.

A display apparatus according to one or more embodiments of the disclosure may include: a liquid crystal panel; and a backlight unit configured to provide light to the liquid crystal panel, wherein the backlight unit may include: a substrate; and a plurality of dimming blocks arranged in a plurality of rows and a plurality of columns on the substrate, each including a red LED, a green LED, and a blue LED, wherein each of the red LED, the green LED, and the blue LED included in each of the plurality of dimming blocks may be divided into different numbers of LED cells, and the divided LED cells may be connected in series.

According to the disclosure, driving efficiency may be increased by varying the number of LED cells of LEDs of each color in local dimming blocks to make block voltages of LEDs of each color similar.

In addition, driving efficiency may be increased by distributing current to each LED cell and driving LED cells with relatively low current.

The number of LED cells of the red LED may be greater than the number of LED cells of the green LED, and the number of LED cells of the green LED may be greater than the number of LED cells of the blue LED.

The number of LED cells of the red LED may be less than a sum of the number of LED cells of the green LED and the number of LED cells of the blue LED.

The blue LED may be divided into two LED cells, the green LED may be divided into three LED cells, and the red LED may be divided into four LED cells.

The display apparatus may further include a plurality of driving devices configured to drive the plurality of dimming blocks, wherein each of the plurality of driving devices may supply driving current to a plurality of light emitting devices included in at least two dimming blocks.

The display apparatus may further include a plurality of current supply lines configured to allow each of the plurality of driving devices to supply a driving current, wherein each of the plurality of current supply lines may be arranged to supply driving current to LEDs of the same color.

The driving device may be disposed on an upper surface or a lower surface of the substrate.

Each of the plurality of dimming blocks may include a predetermined number of light emitting devices.

A backlight unit according to one or more embodiments of the disclosure may include: a substrate; and a plurality of dimming blocks arranged in a plurality of rows and a plurality of columns on the substrate, each including a red LED, a green LED, and a blue LED, wherein each of the red LED, the green LED, and the blue LED included in each of the plurality of dimming blocks may be divided into different numbers of LED cells, and the divided LED cells may be connected in series.

The number of LED cells of the red LED may be greater than the number of LED cells of the green LED, and the number of LED cells of the green LED may be greater than the number of LED cells of the blue LED.

The number of LED cells of the red LED may be less than a sum of the number of LED cells of the green LED and the number of LED cells of the blue LED.

The blue LED may be divided into two LED cells, the green LED may be divided into three LED cells, and the red LED may be divided into four LED cells.

The backlight unit may further include a plurality of driving devices configured to drive the plurality of dimming blocks, wherein each of the plurality of driving devices may supply driving current to a plurality of light emitting devices included in at least two dimming blocks.

The backlight unit may further include a plurality of current supply lines configured to allow each of the plurality of driving devices to supply a driving current, wherein each of the plurality of current supply lines may be arranged to supply driving current to LEDs of the same color.

The driving device may be disposed on an upper surface or a lower surface of the substrate.

Each of the plurality of dimming blocks may include a predetermined number of light emitting devices.

According to the disclosure, driving efficiency may be increased by varying the number of LED cells of LEDs of each color in local dimming blocks to make block voltages of LEDs of each color similar.

In addition, driving efficiency may be increased by distributing current to each LED cell and driving LED cells with relatively low current.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the present disclosure. Thus, it should be understood that the disclosed embodiments described above are merely for illustrative purposes and not for limitation purposes in all aspects.

What is claimed is:

1. A display apparatus comprising:
a liquid crystal panel; and
a backlight unit configured to provide light to the liquid crystal panel,
wherein the backlight unit comprises:
a substrate; and
a plurality of light emitting devices, each comprising ones of red light emitting diodes (LEDs), green LEDs, and blue LEDs,
at least one of the plurality of light emitting devices comprises a plurality of LED cells, the plurality of LED cells comprising a first LED cell, a second LED cell, and a third LED cell,
the first LED cell comprising a first number of the red LEDs,
the second LED cell comprising a second number of the green LEDs,
the third LED cell comprising a third number of the blue LEDs, and
the first LED cell, the second LED cell, and the third LED cell are connected in series.

2. The display apparatus of claim 1, wherein
the first number of the red LEDs of the first LED cell is equal to or greater than the second number of the green LEDs of the second LED cell, and
the second number of the green LEDs of the second LED cell is greater than the third number of the blue LEDs of the third LED cell.

3. The display apparatus of claim 2, wherein the first number of the red LEDs of the first LED cell is less than a sum of the second number of the green LEDs of the second LED cell and the third number of the blue LEDs of the third LED cell.

4. The display apparatus of claim 3, wherein the third number of the blue LEDs of the third LED cell is two, the second number of the green LEDs of the second LED cell is three, and the first number of the red LEDs of the first LED cell is four.

5. The display apparatus of claim 1, further comprising:
a plurality of dimming blocks, comprising at least a first dimming block and a second dimming block, arranged in a plurality of rows and a plurality of columns on the substrate, each comprising the plurality of light emitting devices; and
a plurality of driving devices configured to drive ones of the plurality of dimming blocks,
wherein at least one of the driving devices is configured to drive both the first dimming block and the second dimming block, and
wherein at least one of the driving devices is configured to supply a driving current to ones of the plurality of light emitting devices of the first dimming block and the second dimming block.

6. The display apparatus of claim 5, further comprising:
a plurality of current supply lines configured to allow each of the plurality of driving devices to supply the driving current, the plurality of current supply lines comprising a first current supply line, a second current supply line, and a third current supply line,
wherein the first current supply line is arranged to supply the driving current from the at least one of the driving devices and to the first number of the red LEDs of the at least one of the plurality of light emitting devices,
wherein the second current supply line is arranged to supply the driving current from the at least one of the driving devices and to the second number of the green LEDs of the at least one of the plurality of light emitting devices, and
wherein the third current supply line is arranged to supply the driving current from the at least one of the driving devices and to the third number of the blue LEDs of the at least one of the plurality of light emitting devices.

7. The display apparatus of claim 5, wherein the driving devices are disposed on at least one of an upper surface of the substrate and a lower surface of the substrate.

8. The display apparatus of claim 5, wherein each of the plurality of dimming blocks comprises a preset number of the plurality of light emitting devices.

9. A backlight unit, comprising:
a substrate; and
a plurality of light emitting devices, each comprising ones of red light emitting diodes (LEDs), green LEDs, and blue LEDs,
at least one of the plurality of light emitting devices comprises a plurality of LED cells, the plurality of LED cells comprising a first LED cell, a second LED cell, and a third LED cell,
the first LED cell comprising a first number of the red LEDs,
the second LED cell comprising a second number of the green LEDs,
the third LED cell comprising a third number of the blue LEDs, and
the first LED cell, the second LED cell, and the third LED cell are connected in series.

10. The backlight unit of claim 9, wherein
the first number of the red LEDs of the first LED cell is equal to or greater than the second number of the green LEDs of the second LED cell, and
the second number of the green LEDs of the second LED cell is greater than the third number of the blue LEDs of the third LED cell.

11. The backlight unit of claim 10, wherein the first number of the red LEDs of the first LED cell is less than a sum of the second number of the green LEDs of the second LED cell and the third number of the blue LEDs of the third LED cell.

12. The backlight unit of claim 11, wherein the third number of the blue LEDs of the third LED cell is two, the second number of the green LEDs of the second LED cell is three, and the first number of the red LEDs of the first LED cell is four.

13. The backlight unit of claim 9, further comprising:
a plurality of dimming blocks, comprising at least a first dimming block and a second dimming block, arranged in a plurality of rows and a plurality of columns on the substrate, each comprising the plurality of light emitting devices; and
a plurality of driving devices configured to drive ones of the plurality of dimming blocks,
wherein at least one of the driving devices is configured to drive both the first dimming block and the second dimming block, and
wherein at least one of the driving devices is configured to supply a driving current to ones of the plurality of light emitting devices of the first dimming block and the second dimming block.

14. The backlight unit of claim 13, further comprising:
a plurality of current supply lines configured to allow each of the plurality of driving devices to supply the driving current, the plurality of current supply lines comprising a first current supply line, a second current supply line, and a third current supply line,
wherein the first current supply line is arranged to supply the driving current from the at least one of the driving devices and to the first number of the red LEDs of the at least one of the plurality of light emitting devices,
wherein the second current supply line is arranged to supply the driving current from the at least one of the driving devices and to the second number of the green LEDs of the at least one of the plurality of light emitting devices, and
wherein the third current supply line is arranged to supply the driving current from the at least one of the driving devices and to the third number of the blue LEDs of the at least one of the plurality of light emitting devices.

15. The backlight unit of claim 13, wherein the driving devices are disposed on at least one of an upper surface of the substrate and a lower surface of the substrate.
